(19) United States
(12) Patent Application Publication
(10) Pub. No.: US 2025/0269685 A1
(43) Pub. Date: Aug. 28, 2025

(54) DEFORMABLE WHEEL ASSEMBLY

(71) Applicant: ABLE MOTORS CO., LTD., Siheung-si. Gyeonggi-do (KR)

(72) Inventor: Won-jae KIM, Seoul (KR)

(73) Assignee: ABLE MOTORS CO., LTD., Siheung-si. Gyeonggi-do (KR)

(21) Appl. No.: 18/857,938

(22) PCT Filed: Apr. 17, 2023
(86) PCT No.: PCT/KR2023/005146

§ 371 Date: Oct. 18, 2024

(30) Foreign Application Priority Data
Apr. 19, 2022 (KR) 10-2022-0048297
May 20, 2022 (KR) 10-2022-0062058

(51) Int. Cl. B60B 19/02; B60B 19/04; F16H 57/02

(52) U.S. Cl. CPC B60B 19/02; B60B 19/04; F16H 57/02; F16H 2057/02013

(57) ABSTRACT

A deformable wheel assembly according to the present invention is characterized by comprising: a main frame provided with a main driving shaft that is connected to and rotated by a driving means of a driving body including a vehicle; a rotation driving unit which is provided on the main frame and connected to the driving means, and provides rotational power separately from the main driving shaft; an extendable driving unit provided on the main frame and connected to the driving means; and a link unit which is provided on the main frame and forms the outer shape of a wheel, and changes the shape of the wheel into a deformed shape including a circular or elliptical shape by the operation of the extendable driving unit. The rotation driving unit is connected to a wheel unit and provides rotational power separately from the main driving shaft.

### TECHNICAL FIELD

The present disclosure relates to a wheel and, more specifically, to a transformable wheel assembly in which all operations are possible only by a rotating part of a main wheel shaft without an actuator or a track motor inside the wheel.

### BACKGROUND ART

In general, due to the structural and morphological characteristics, it is often difficult or even impossible for wheels to ascend or descend stairs or traverse rough terrain.

In particular, for standard two-wheeled wheelchairs, it is nearly impossible to independently climb up and down stairs, which is a common problem for all mobile vehicles equipped with wheels.

Recently, there has been a growing demand for mobile vehicles and driving wheels that enable active driving in an environment that is becoming increasingly complex and diverse.

In particular, a conventional transformable wheel, which has therein an actuator that changes length and a track motor, has a complicated configuration in which power and hydraulic line connections rotate along with a main shaft around which the entire wheel rotates. As a result, electrical noise and durability problems due to its complex structure are caused.

### PRIOR ART DOCUMENTS

(Patent Document 1) Korean Patent No. 10-1841197 (published on Mar. 16, 2018, in the name of Korea University Research Management System)

### DISCLOSURE OF INVENTION

### Technical Problem

Accordingly, the present disclosure provides a transformable wheel assembly in which all operations can be performed solely by a rotating part of a main wheel shaft without an actuator and a track motor inside the wheel.

### Solution to Problem

An aspect of the present disclosure may provide a transformable wheel assembly including: a main frame provided with a main driving shaft that is connected to and rotated by driving means of a driving body including a vehicle; a rotational driving part provided on the main frame and connected to the driving means, the rotational driving part being configured to provide rotational power separately from the main driving shaft; an extendable driving part provided on the main frame and connected to the driving means; and a link unit provided on the main frame and forming an outer shape of a wheel, the link unit being configured to transform a shape of the wheel into a modified shape including a circular or elliptical shape in response to operation of the extendable driving part. The rotational driving part is connected to the wheel part and provides rotational power separately from the main driving shaft.

The rotational driving part may include: a driving power transmission part provided on the main frame and connected to the driving means to receive power; a first driven power transmission part provided on the main frame and meshed with a driving power transmission gear of the driving power transmission part, the first driven power transmission part being configured to receive and transmit rotational power to the wheel part; and a second driven power transmission part provided on the main frame opposite to the first driven power transmission part and meshed with the driving power transmission gear, the second driven power transmission part being configured to receive and transmit rotational power to the wheel part.

The extendable driving part may include: an extendable power transmission part provided on the main frame and connected to the driving means to receive power; a first moving part provided on the main frame and including a first extendable housing meshed with the extendable power transmission gear of the extendable power transmission part, the first extendable housing being configured to move along a longitudinal direction of the main frame using power received from the extendable power transmission gear; and a second moving part provided on the main frame opposite to the first transmission part and including a second extendable housing meshed with the extendable power transmission gear, the second extendable housing being configured to move in an opposite direction to the first transmission part using power received from the extendable power transmission part. When the first extendable housing moves, a first gear and a first unit gear of the rotational driving part may also move along with the first extendable housing, and when the second extendable housing moves, a second gear and a second unit gear of the rotational driving part may also move along with the second extendable housing.

The link unit may include a plurality of first moving bodies provided to move in a front guide hole of the main frame and coupled to a first extendable guider provided in the extendable driving part to be moved along with the first extendable guider; a plurality of second moving bodies provided to move in a rear guide hole of the main frame and coupled to a second extendable guider provided in the extendable driving part to be moved along with the second extendable guider; a pair of base support plates respectively coupled to the plurality of first moving bodies and the plurality of second moving bodies arranged on one side of the main frame and respectively coupled to the plurality of first moving bodies and the plurality of second moving bodies arranged on the other side of the main frame to be moved in opposite directions; a link part including a plurality of link bodies respectively provided on the pair of base support plates that are close to each other; and an end link having one side rotatably coupled to the pair of base support plates and the other side coupled to the link part to be transformed into the modified shape.

The link unit may further include support rings provided on the pair of base support plates to support the first moving body and the second moving body and to support one side of the end link.

The pair of base support plates may be engaged with a connecting frame provided on the main frame such that the movement distance on one side is limited.

The main frame may include a front guide configured to guide movement of a first extendable guider and a second extendable guider of the extendable driving part; and a rear guide configured to guide movement of a first guider and a second guider of the rotational driving part. The wheel part may be provided on the link unit to be transformed into a shape corresponding to the modified shape of the link unit.

### Advantageous Effects of Invention

According to the embodiments of the present disclosure, it is possible to provide a transformable wheel assembly, enabling active driving in increasingly complex and diverse environments.

In addition, the embodiments are able to simplify a coupling structure between a mobile vehicle and a driving part by providing a structure in which a single driving body transforms between a wheel and a continuous track.

Furthermore, the embodiments are applicable to the driving parts of various mobile vehicles, including a wheelchair for the disabled and the elderly, a mobile vehicle for parcel delivery service, a robot for use at a disaster site, a robot at a construction site, and an unmanned military mobile vehicle.

In addition, the embodiments are able to maintain high energy efficiency when driving with circular wheels and provide high driving ability to overcome obstacles when using continuous tracks.

### BRIEF DESCRIPTION OF DRAWINGS

FIG. 1 is a view schematically illustrating a transformable wheel assembly according to an embodiment of the disclosure;

FIG. 2 is a rear side perspective view of FIG. 1;

FIG. 3 is a cross-sectional view taken along line A-A′ of FIG. 1;

FIG. 4 is a perspective view illustrating an area of the main frame of FIG. 1;

FIG. 5 is a rear side perspective view of FIG. 4;

FIG. 6 is a perspective view of the main frame illustrated in FIG. 4;

FIG. 7 is a rear side perspective view of FIG. 6;

FIG. 8 is a perspective view schematically illustrating then extendable driving unit of FIG. 3;

FIG. 9 is a view illustrating the link unit of FIG. 1 that is provided on a rear frame;

FIG. 10 is a view illustrating an area of a pair of base support plates of FIG. 9;

FIG. 11 is a perspective view illustrating the link unit and some end links of FIG. 10;

FIG. 12 is a view illustrating an upper area of the end link of FIG. 1;

FIG. 13 is a view in which some components of the extendable driving unit illustrated in FIG. 1 are omitted.

FIG. 14 is a view in which the front frame, the first housing, and the like illustrated in FIG. 13 are omitted.

FIG. 15 is a view illustrating the configuration of the rotational driving unit of an embodiment so that it is clearly visible; and

FIG. 16 is a view illustrating the state of use of an embodiment in which the wheel unit part has an elliptical shape due to the folding of the link unit.

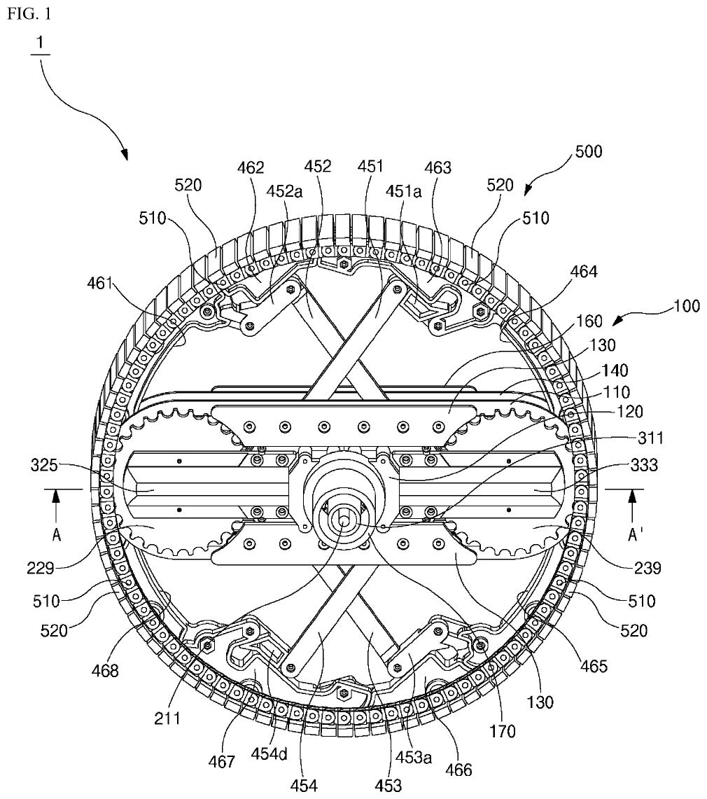

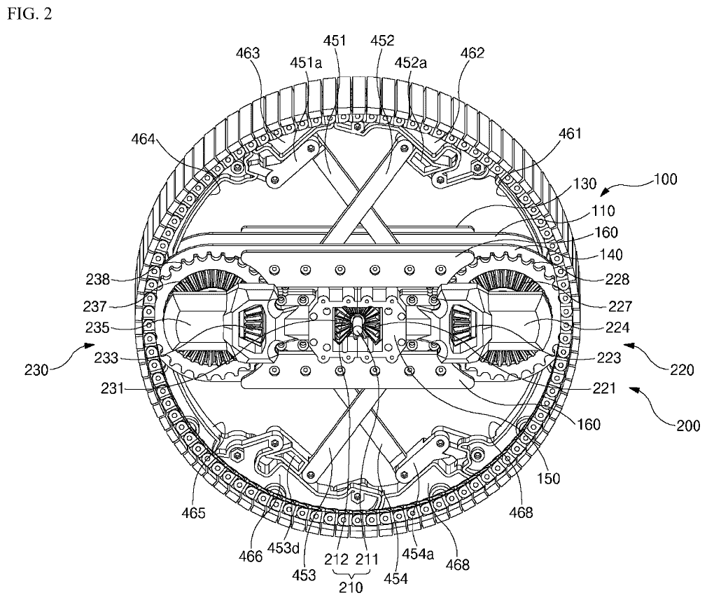

### BEST MODE FOR CARRYING OUT THE INVENTION

To fully understand the present disclosure, the operational advantages of the present disclosure, and the effects achieved by implementing the present disclosure, it is necessary to refer to the accompanying drawings exemplifying embodiments of the present disclosure and the content illustrated therein.

Hereinafter, the present disclosure will be described in detail by explaining embodiments of the present disclosure with reference to the attached drawings. The same reference numerals in the respective drawings indicate the same components.

A transformable wheel assembly 1 according to the present embodiment includes: a main frame 100 provided with a main driving shaft 170 that is connected to and rotated by driving means of a driving body including a vehicle; a rotational driving part 200 provided on the main frame 100 and connected to the driving means to provide rotational power separately from the main driving shaft 170; an extendable driving part 300 provided on the main frame 100 and connected to the driving means; a link unit 400 provided on the main frame 100 and forming the outer shape of a wheel, the link unit being configured to transform the shape of the wheel into a modified shape including a circular or elliptical shape in response to the operation of the extendable driving part 300; and a wheel part 500 provided on the link unit 400 and transformed into a shape corresponding to the modified shape of the link unit 400.

The main frame 100 may be connected to and rotated by the driving means of the driving device including a wheelchair for the disabled and the elderly, a mobile vehicle for parcel delivery, a robot for use at a disaster site, a robot at a construction site, and an unmanned military mobile vehicle.

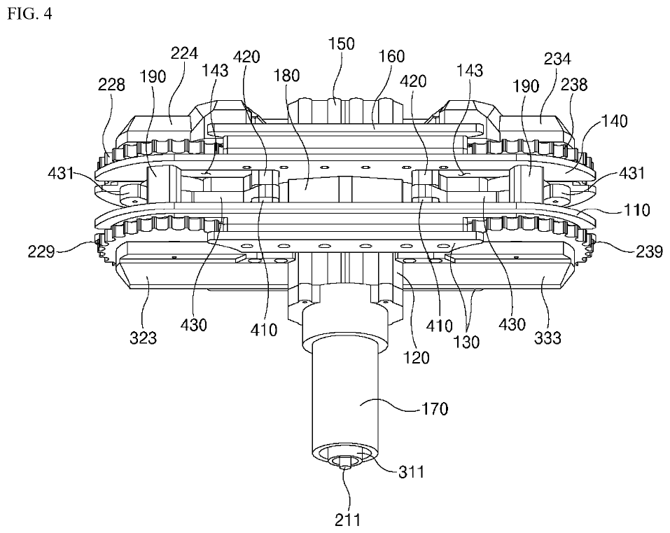

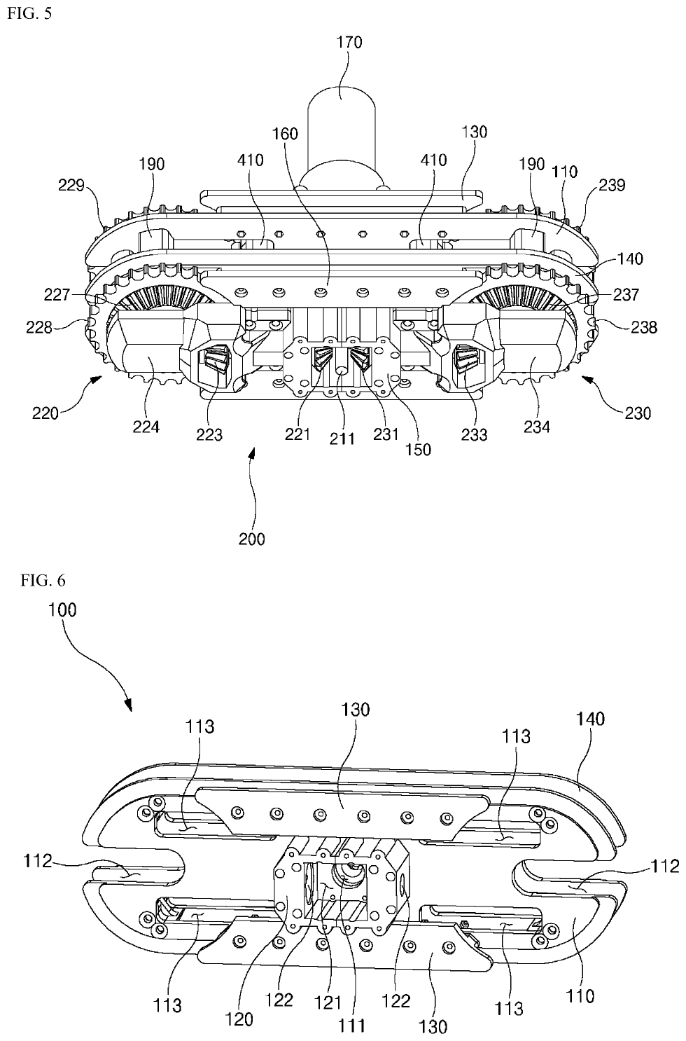

In this embodiment, as illustrated in FIG. 4, the main frame 100 includes: a front frame 110; a front support block 120 coupled to the front of the front frame 110; a pair of front guides 130 respectively provided at the upper and lower portions of the front frame 110 to guide the movement of a first extendable guider 324 and a second extendable guider 334 of the extendable driving part 300; a rear frame 140 arranged at the rear of the front frame 110 to be spaced apart from the front frame 110; a rear support block 150 coupled to the rear of the rear frame 140; a pair of rear guides 160 respectively provided at the upper and lower portions of the rear frame 140 to guide the movement of a first guider 225 and a second guider 235 of the rotational driving part 200; a main driving shaft 170 detachably coupled to the front support block 120 and connected to the driving means to be rotated; a connecting frame 180 detachably connecting the front frame 110 and the rear frame 140; and a plurality of support posts 190, which are coupled to the front frame 110 at one side and to the rear frame 140 at the other side to support edges of the front frame and the rear frame 140.

As illustrated in FIG. 6, a first frame hole 111 may be provided in the front frame 110 of the main frame 100, and an extendable power transmission gear 312 of the extendable driving part 300 may be rotatably coupled to the first frame hole 111. In this embodiment, the extendable driving shaft 311 of the extendable driving part 300 may be connected to the extendable power transmission gear 312 through the first frame hole 111.

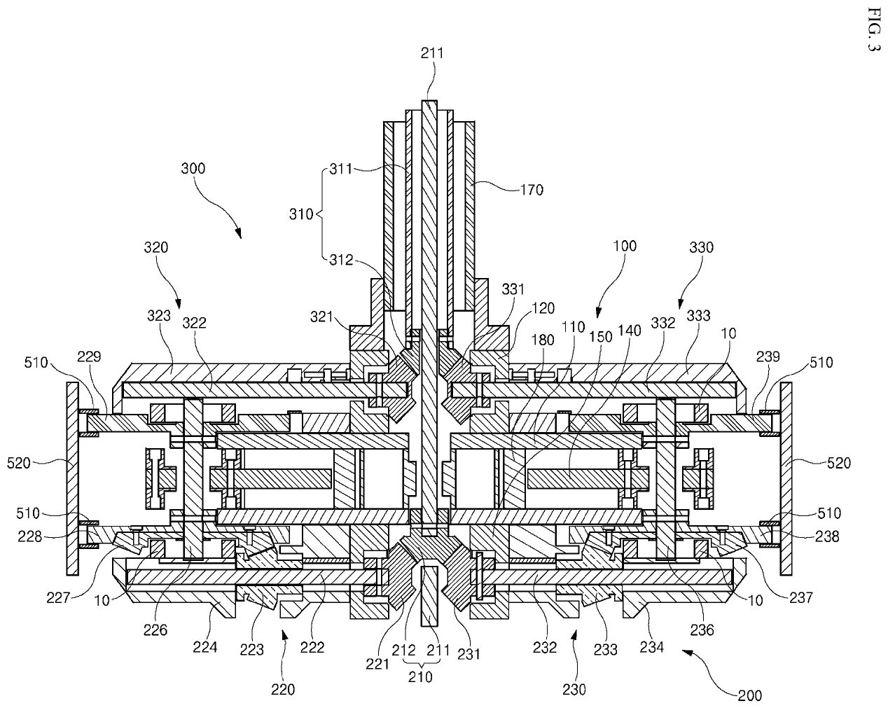

In this embodiment, as illustrated in FIG. 6, the front frame 110 may be provided with a pair of front cut holes 112 at the edge thereof. In this embodiment, a first driven power transmission shaft 226 and a second driven power transmission shaft 236 illustrated in FIG. 3 may be moved in the pair of front cut holes 112 toward or away from each other.

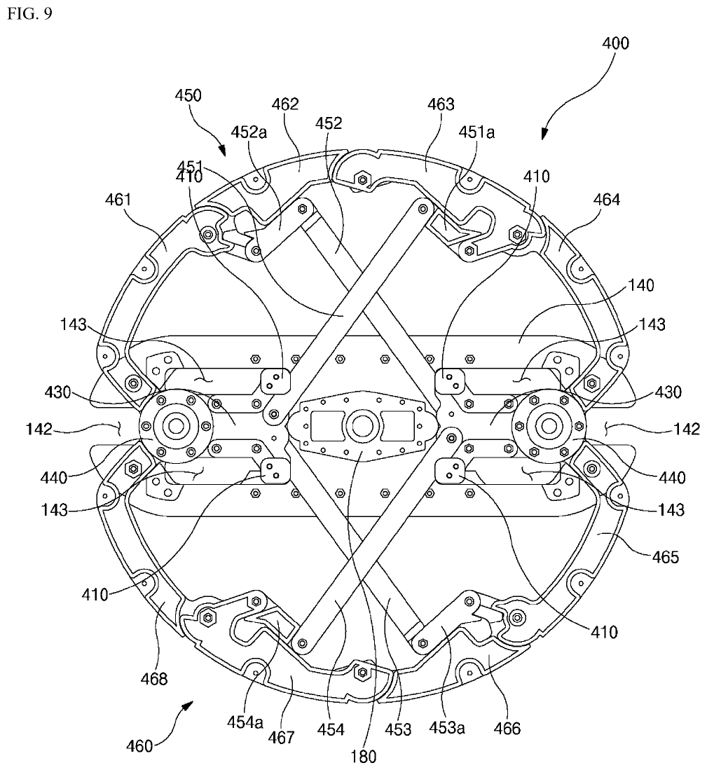

In addition, in this embodiment, four front guide holes 113 are provided in the front frame (110), as illustrated in FIG. 6. In this embodiment, four first moving bodies 410 illustrated in FIG. 9 may be supported in the four front guide holes 113, and each first moving body 410 may be movable in the longitudinal direction of the corresponding front guide 130 hole 113.

The front support block 120 of the main frame 100 may be coupled to the front wall of the front frame 110 as illustrated in FIG. 6 to serve as a detachable coupling location for the main driving shaft 170, and may rotatably support the first extendable driven gear 321 and the first extendable driven shaft 322, and the second extendable driven gear 331 and the second extendable driven shaft 332.

In this embodiment, the front support block 120 is provided with a front space 121 as illustrated in FIG. 6. In this embodiment, the extendable power transmission gear 312, the first extendable driven gear 321, and the second extendable driven gear 331 illustrated in FIG. 3 may be rotatably accommodated in the front space 121.

In addition, in this embodiment, the front support block 120 may be provided with a pair of first block holes 122, which are spaced apart from each other, as illustrated in FIG. 6. In this embodiment, the pair of first block holes 122 may be respectively provided in two opposite side walls of the front support block 120 and rotatably support the first extendable driven shaft 322 and second the extendable driven shaft 332 illustrated in FIG. 3.

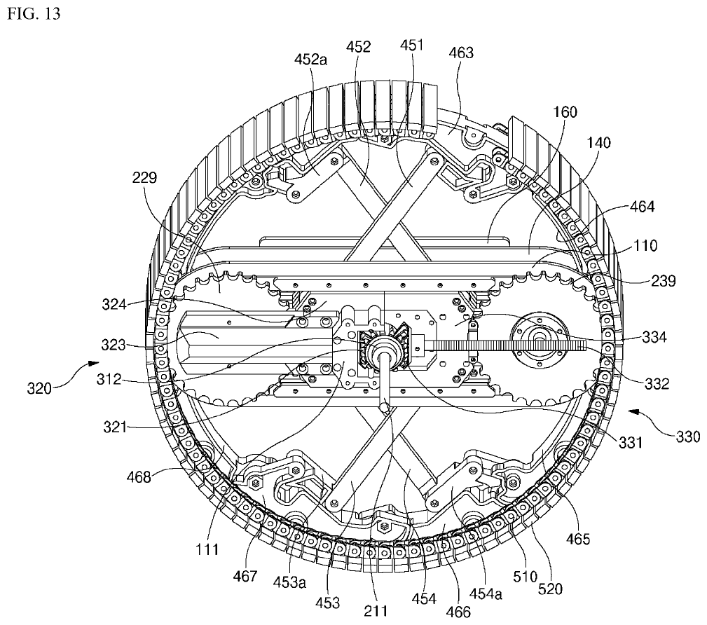

On the pair of front guides 130 of the main frame 100, the upper and lower portions of the first extendable guider 324 and the upper and lower portions of the second extendable guider 334 illustrated in FIG. 13 may be slidably supported.

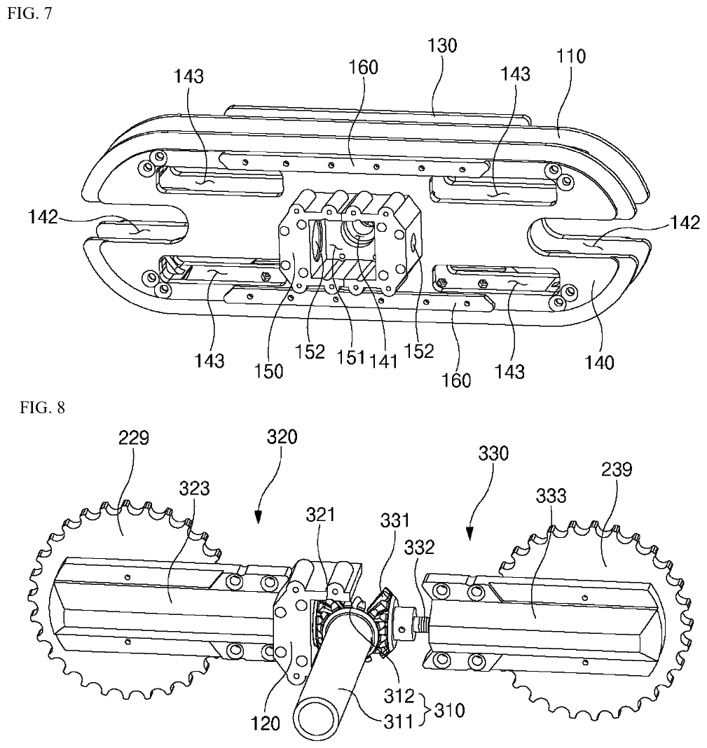

As illustrated in FIG. 7, a second frame hole 141 may be provided in the rear frame 140 of the main frame 100, and a driving power transmission gear 212 of the rotational driving part 200 may be rotatably coupled to the second frame hole 141. In this embodiment, a rotational driving shaft 211 of the rotational driving part 200 may be connected to the driving power transmission gear 212 through the second frame hole 141.

In this embodiment, as illustrated in FIG. 7, the rear frame 140 may be provided with a pair of rear cut holes 142 at the edge thereof. In this embodiment, the first driven power transmission shaft 226 and the second driven power transmission shaft 236 illustrated in FIG. 3 may be moved in the pair of rear cut holes 142 toward or away from each other.

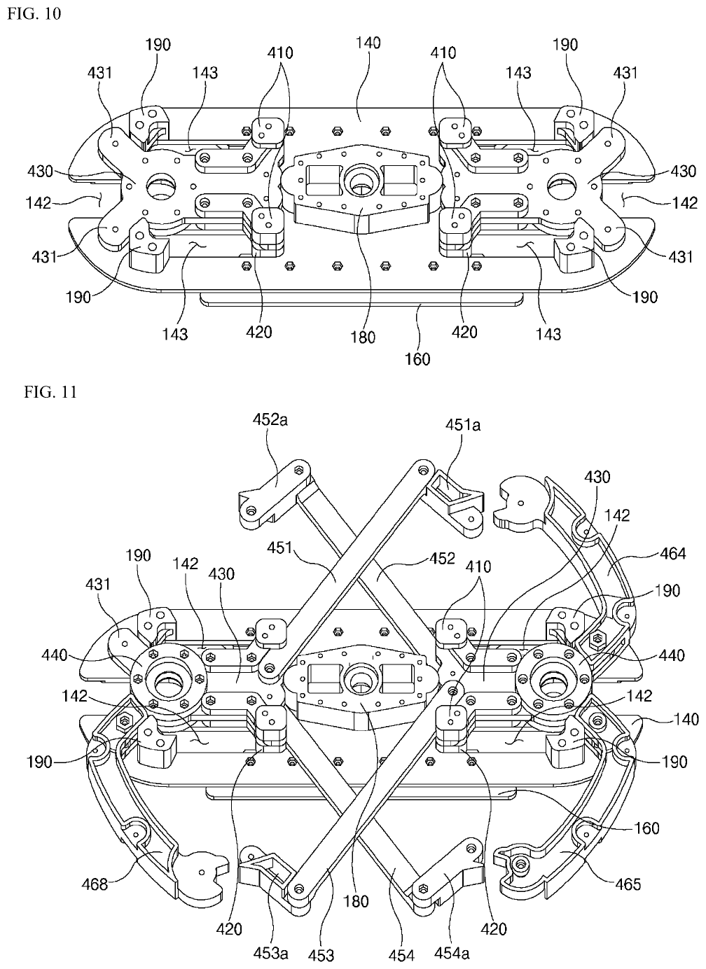

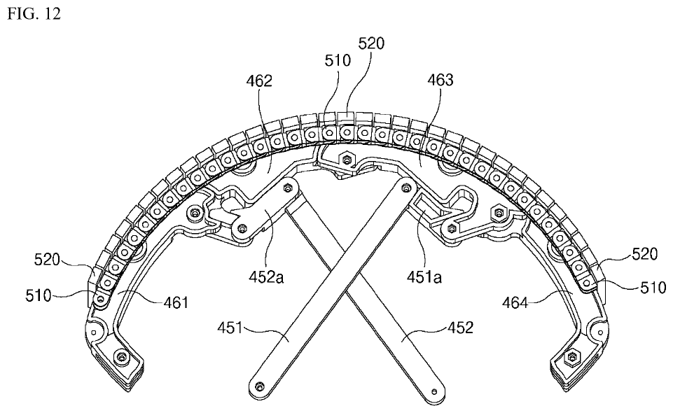

In addition, in this embodiment, four rear guide 160 holes 143 are provided in the rear frame 140, as illustrated in FIG. 7. In this embodiment, four second moving bodies 420 illustrated in FIG. 10 may be supported in the four rear guide 160 holes 143, and each second moving body 420 may be movable in the longitudinal direction of the corresponding rear guide 160 hole 143.

The rear support block 150 of the main frame 100 may be coupled to the front wall of the rear frame 140 as illustrated in FIG. 7 to serve as a detachable coupling location for the main driving shaft 170, and may rotatably support the driving power transmission gear 212, the first driven gear 221, and the second driven gear 231.

In this embodiment, the rear support block 150 is provided with a rear space 151 as illustrated in FIG. 7. In this embodiment, the driving power transmission gear 212, the first driven gear 221, and the second driven gear 231 illustrated in FIG. 3 may be rotatably meshed with each other in the rear space 151.

In addition, in this embodiment, the rear support block 150 may be provided with a pair of second block holes 152 which are spaced apart from each other, as illustrated in FIG. 7. In this embodiment, the pair of second block holes 152 may be respectively provided in two opposite side walls of the rear support block 150 and rotatably support the first driven shaft 222 and the second driven shaft 232 illustrated in FIG. 3.

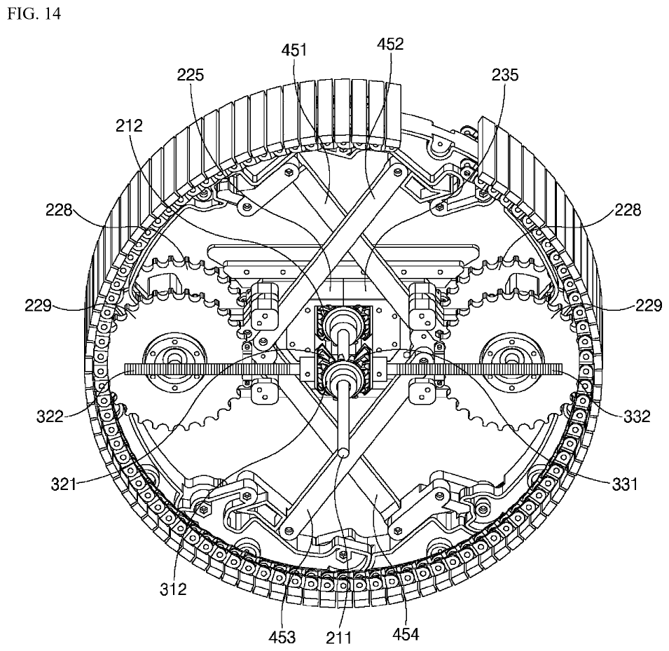

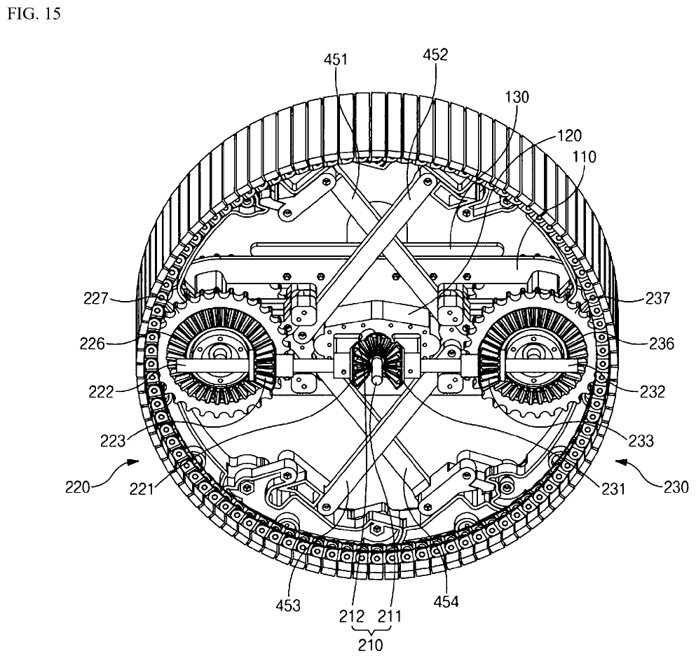

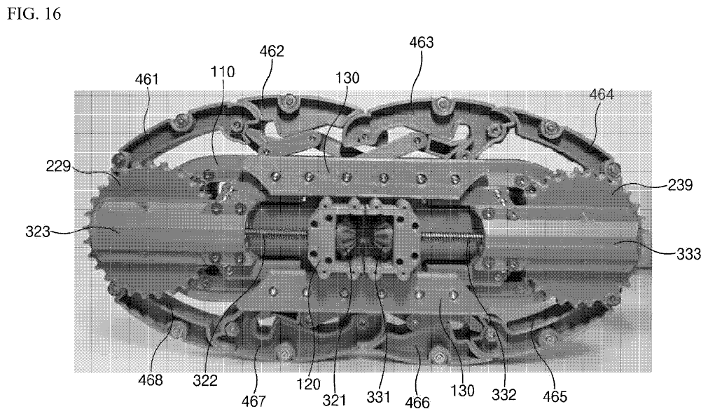

On the pair of rear guides 160 of the main frame 100, the upper and lower portions of the first guider 225 and the upper and lower portions of the second guider 235 illustrated in FIG. 14 may be slidably supported.

The main driving shaft 170 of the main frame 100 may be detachably bolted to the front support block 120 illustrated in FIG. 4 and may be connected to the driving means to be rotated.

The connecting frame 180 of the main frame 100 may be detachably bolted to each of the front frame 110 and the rear frame 140.

In this embodiment, the rotational driving shaft 211 may pass through the interior of the main frame 100, as illustrated in FIG. 3.

The plurality of support posts 190 of the main frame 100 may be detachably bolted to each of the front frame 110 and the rear frame 140.

The rotational driving part 200 may be connected to the driving means separately from the main driving shaft 170 provided in the main frame 100 and rotate the wheel part 500 clockwise or counterclockwise.

In this embodiment, as illustrated in FIG. 3, the rotational driving part 200 includes: a driving power transmission part 210 provided on the main frame 100 and connected to the driving means to transmit power; a first driven power transmission part 220 provided on the main frame 100 and meshed with the driving power transmission gear 212 of the driving power transmission part 210 to receive and transmit rotational power to the wheel part 500; and a second driven power transmission part 230 provided on the main frame 100 opposite to the first driven power transmission part 220 and meshed with the driving power transmission gear 212 to provide the received rotational power to the wheel part 500.

As illustrated in FIG. 3, the driving power transmission part 210 of the rotational driving part 200 includes: the rotational driving shaft 211 arranged inside the extendable driving shaft 311 and having a lower portion rotatably supported by the rear frame 140; and the driving power transmission gear 212 coupled to the lower portion of the rotational driving shaft 211 to rotate in the same direction as the rotational driving shaft and arranged inside the rear support block 150.

As illustrated in FIG. 3, the first driven power transmission part 220 of the rotational driving part 200 is provided on the left side of the main frame 100 and transmits the rotational power of the driving power transmission gear 212 to a chain member 510 arranged on the left side with respect to FIG. 3.

In this embodiment, as illustrated in FIG. 3, the first driven power transmission part 220 includes: a first driven gear 221 meshed with the driving power transmission gear 212 to be rotated inside the rear support block 150; a first driven shaft 222 having one end coupled with the first driven gear 221 to be rotated in the same direction as the first driven gear 221; a first unit driven gear 223 coupled to the first driven shaft 222 to be rotated in the same direction as the first driven shaft 222; a first housing 224 configured to rotatably support the first driven shaft 222 and the first unit driven gear 223; a first guide detachably coupled to the first housing 224 at one side and slidably supported on the rear guide 160 at the other side to guide the movement of the housing 224; a first driven power transmission shaft 226 rotatably supported by the front frame 110 and the rear frame 140; a first driven bevel gear 227 coupled to the first driven power transmission shaft 226 to rotate along with the first driven power transmission shaft 226 and meshed with the first unit driven gear 223; a first gear 228 coupled to the first driven power transmission shaft 226 to rotate along with the first driven power transmission shaft 226 and having a central portion coupled with the first driven bevel gear 227 and an edge engaged with the chain member 510 of the wheel part 500 to rotate the chain member 510; and a first unit gear 229 coupled to the first driven power transmission shaft 226 disposed on the front frame 110 to be rotated along with the first driven power transmission shaft 226 and having an edge engaged with the chain member 510 of the wheel part 500 to rotate the chain member 510.

In this embodiment, the first driven gear 221 and the first unit driven gear 223 may be coupled to the first driven shaft 222 to be rotated in the same direction as the first driven shaft 222.

In this embodiment, the first driven bevel gear 227, the first gear 228, and the first unit gear 229 may be coupled to the first driven power transmission shaft 226 to be rotated in the same direction as the first driven power transmission shaft 226.

As illustrated in FIG. 3, the second driven power transmission part 230 of the rotational driving part 200 is provided on the right side of the main frame 100 and transmits the rotational power of the driving power transmission gear 212 to the chain member 510 arranged on the right side with reference to FIG. 3.

In this embodiment, as illustrated in FIG. 3, the second driven power transmission part 230 includes: a second driven gear 231 meshed with the driving power transmission gear 212 to be rotated inside the rear support block 150; a second driven shaft 232 having one end coupled with the second driven gear 231 to be rotated in the same direction as the second driven gear 231; a second unit driven gear 233 coupled to the second driven shaft 232 to be rotated in the same direction as the second driven shaft 232; a second housing 234 configured to rotatably support the second driven shaft 232 and the second unit driven gear 233; a second guide detachably coupled to the second housing 234 at one side and slidably supported on the rear guide 160 at the other side to guide the movement of the second housing a second driven power transmission shaft 236 234; rotatably supported by the front frame 110 and the rear frame 140; a second driven bevel gear 237 coupled to the second driven power transmission shaft 236 to rotate along with the second driven power transmission shaft 236 and meshed with the second unit driven gear 233; a second gear 238 coupled to the second driven power transmission shaft 236 to rotate along with the second driven power transmission shaft 236 and having a central portion coupled with the second driven bevel gear 237 and an edge engaged with the chain member 510 of the wheel part 500 to rotate the chain member 510; and a second unit gear 239 coupled to the first driven power transmission shaft 236 disposed on the front frame 110 to be rotated along with the second driven power transmission shaft 236 and having an edge engaged with the chain member 510 of the wheel part 500 to rotate the chain member 510.

In this embodiment, the second driven gear 231 and the second unit driven gear 233 may be coupled to the second driven shaft 232 to be rotated in the same direction as the second driven shaft 232.

In this embodiment, the second driven bevel gear 237, the second gear 238, and the second unit gear 239 may be coupled to the second driven power transmission shaft 236 to be rotated in the same direction as the second driven power transmission shaft 236.

The operation of the rotational driving part 200 is described below.

When the rotational driving shaft 211 rotates clockwise with reference to FIG. 3, the driving power transmission gear 212 coupled to the rotational driving shaft 211 also rotates clockwise.

The first driven gear 221 meshed with the driving power transmission gear 212 rotates clockwise with reference to FIG. 3, and the first unit driven gear 223 connected to the first driven gear 221 and the first driven shaft 222 also rotates clockwise. At this time, the first driven bevel gear 227 vertically meshed with the first unit driven gear 223 also rotates clockwise, the first driven power transmission shaft 226 and the first gear 228 to which the first driven gear 221 is coupled also rotate clockwise, and the first unit gear 229 coupled to the first driven power transmission shaft 226 also rotates clockwise. As a result, the chain member 510 arranged on the left side may rotate from the left to the right, that is, counterclockwise, with reference to FIG. 3.

In addition, the second driven gear 231 meshed with the transmission gear rotates clockwise based on FIG. 3, and the second unit driven gear 233 connected to the second driven gear 231 and the second driven shaft 232 also rotates clockwise. At this time, the second driven bevel gear 237 vertically meshed with the second unit driven gear 233 also rotates clockwise, the second driven power transmission shaft 236 and the second gear 238 to which the second driven gear 231 is coupled also rotate clockwise, and the second unit gear 239 coupled to the second driven power transmission shaft 236 also rotates clockwise. As a result, the chain member 510 arranged on the right side may rotate from the left to the right, that is, counterclockwise, with reference to FIG. 3.

The extendable driving part 300 may be provided on the main frame 100 to transform the shape of the wheel part 500 into a modified shape including a circular or elliptical shape.

In this embodiment, as illustrated in FIG. 3, the extendable driving part 300 includes: an extendable power transmission part 310 provided on the main frame 100 and connected to the driving means to receive power; a first moving part 320 provided on the main frame 100 and including a first extendable housing 323 moved in the longitudinal direction of the main frame 100 by power received by being meshed with the extendable power transmission gear of 312 the extendable power transmission part 310; and a second moving part 330 provided on the main frame 100 opposite to a first transmission part and including a second extendable housing 333 meshed with the extendable power gear 312 and moved in the opposite transmission direction to the first transmission part by received power.

In this embodiment, when the extendable power transmission part 310 is driven, the first moving part 320 and the second moving part 330 may move in a direction away from each other, or conversely, may move in a direction closer to each other. In addition, in this embodiment, the first moving part 320 and the second moving part 330 may move the same distance.

As illustrated in FIG. 3, the extendable power transmission part 310 of the extendable driving part 300 includes: the extendable driving shaft 311 arranged between the main driving shaft 170 and the rotational driving shaft 211 and connected to an external driving means to be rotated; and the extendable power transmission gear 312 coupled to an end of the extendable driving shaft 311 to rotate in the same direction as the extendable driving shaft 311.

As illustrated in FIG. 3, the first moving part 320 of the extendable driving part 300 includes: the first extendable driven gear 321 meshed with the extendable power transmission gear 312 to be rotated inside the front support block 120; the first extendable driven shaft 322 coupled at one end to the first extendable driven gear 321 to be rotated in the same direction as the first extendable driven gear 321 and including a plurality of screw threads on the outer wall thereof; the first extendable housing 323 screw-coupled to the first extendable driven shaft 322 to move in the direction of loosening or fastening of the screw when the first extendable driven shaft 322 rotates, the first extendable driven shaft 322 being rotatably coupled inside the first extendable housing 323; and the first extendable guider 324 detachably coupled to the first at one extendable housing 323 side and slidably supported on the front guide 130 at the other side.

In this embodiment, when the first extendable driven gear 321 and the first extendable driven shaft 322 rotate, the first extendable housing 323 may move to the left with reference to FIG. 3, and in this state, when the first extendable driven gear 321 and the first extendable driven shaft 322 rotate in the opposite direction, the first extendable housing 323 move to the right with reference to FIG. 3.

In addition, in this embodiment, when the first extendable housing 323 moves, the first driven power transmission part 220 may move together with the first extendable housing 323 except for the first driven gear 221 and the first driven shaft 222. Specifically, the first driven gear 221 is coupled to the first driven shaft 222 having a square shape and rotates together with the first driven shaft 222, but when the first housing 224 moves, the first driven gear may move in the longitudinal direction of the first driven shaft 222 by the force of the first housing 224. In the present embodiment, since the first guider 225 is coupled to the first housing 224 and moves together with the first housing 224, and the first guider 225 is coupled to a plurality of second moving bodies 420 illustrated in FIG. 10 and moves together with the second moving bodies 420, the smooth movement of the first housing 224 may be achieved.

As illustrated in FIG. 3, the second moving part 330 of the extendable driving part 300 includes: the second extendable driven gear 331 meshed with the extendable power transmission gear 312 to be rotated inside the front support block 120; the second extendable driven shaft 332 coupled at one end to the second extendable driven gear 331 to be rotated in the same direction as the second extendable driven gear 331 and including a plurality of screw threads on the outer wall thereof; the second extendable housing 333 screw-coupled to the second extendable driven shaft 332 to move in the direction of loosening or fastening of the screw when the second extendable driven shaft 332 rotates, in which the second extendable driven shaft 332 is rotatably coupled inside the second extendable housing 333; and the second extendable guider 334 detachably coupled to the second extendable housing 323 at one side and slidably supported on the front guide 130 at the other side.

In this embodiment, when the second extendable driven gear 331 and the second extendable driven shaft 332 rotate, the second extendable housing 333 may move to the right with reference to FIG. 3, and in this state, when the second extendable driven gear 331 and the second extendable driven shaft 332 rotate in the opposite direction, the second extendable housing 333 move to the left with reference to FIG. 3.

In addition, in this embodiment, when the second extendable housing 333 moves, the second driven power transmission part 230 may move together with the second extendable housing 333 except for the second driven gear 231 and the second driven shaft 232. Specifically, the second driven gear 231 is coupled to the second driven shaft 232 having a square shape and rotates together with the second driven shaft 232, but when the second housing 234 moves, the second driven gear may move in the longitudinal direction of the second driven shaft 232 by the force of the second housing 234. In the present embodiment, since the second guider 235 is coupled to the second housing 234 and moves together with the second housing 234, and the second guider 235 is coupled to a plurality of second moving bodies 420 illustrated in FIG. 10 and moves together with the second moving bodies 420, the smooth movement of the second housing 234 may be achieved.

The link unit 400 is provided on the main frame 100 to form the outer shape of the wheel part 500 and may transform the shape of the wheel part 500 into a modified shape including a circular or elliptical shape in response to the operation of the extendable driving part 300.

In this embodiment, as illustrated in FIG. 9, the link unit 400 includes: a plurality of first moving bodies 410; a plurality of second moving bodies 420 arranged to move in the rear guide 160 hole 143 of the main frame 100 and coupled to a second extendable guider 334 provided in the extendable driving part 300 to move along with the second extendable guider 334; a pair of base support plates 430 respectively coupled to the plurality of first moving bodies 410 and the plurality of second moving bodies 420 arranged on one side of the main frame 100 and respectively coupled to the plurality of first moving bodies 410 and the plurality of second moving bodies 420 arranged on the other side of the main frame 100 to move in opposite directions; a link part 450 including a plurality of link bodies that are respectively provided on the pair of base support plates 430 that are close to each other; and an end link 460 having one side rotatably coupled to the pair of base support plates 430 and coupled to the link part 450 to be transformed into the modified shape of the wheel part 500.

The plurality of first moving bodies 410 of the link unit 400 are provided to move in the front guide 130 hole 113 of the front frame 110 and are coupled to the first extendable guider 324 provided in the extendable driving part 300 to move along with the first extendable guide 324. In the present embodiment, the plurality of first moving bodies 410 may move in the longitudinal direction of the front guide 130 hole 113.

In the present embodiment, the plurality of first moving bodies 410 may be provided in a total of four, as illustrated in FIG. 10, and may have an approximately curved L-shape.

The plurality of second moving bodies 420 of the link unit 400 may be provided to move in the rear guide 160 hole 143 of the rear frame 140, as illustrated in FIG. 10, and may be coupled to the second guider provided in the rotational driving part 200 to move along with the second guider 235. In the present embodiment, the plurality of second moving bodies 420 may move in the longitudinal direction of the rear guide 160 hole 143.

In the present embodiment, the plurality of second moving bodies 420 may be provided in a total of four, as illustrated in FIG. 10, and may have an approximately curved L-shape.

The base support plate 430 of the link unit 400 is disposed between the first moving bodies 410 and the second moving bodies 420, as illustrated in FIG. 10, and may be coupled to each of the first moving bodies 410 and the second moving bodies 420 to move together with the first moving bodies 410 and the second moving bodies 420.

In this embodiment, a pair of extensions 431 are provided at one side edge of the base support plate 430 to be spaced apart from each other, as illustrated in FIG. 10. In this embodiment, a first end link 461 and an eighth end link 468 may be rotatably coupled to the pair of extensions 431 disposed on the left side with reference to FIG. 9, and a fourth end link 464 and a fifth end link 465 may be rotatably coupled to the pair of extensions 431 disposed on the right side.

In addition, a hole is provided in the central portion of the base support plate 430 in this embodiment, and the first driven power transmission shaft 226 may be rotatably supported in the hole provided in the base support plate 430 disposed on the left side with reference to FIG. 10, and the second driven power transmission shaft 236 may be rotatably supported in the hole provided in the base support plate 430 disposed on the right side.

As illustrated in FIG. 11, support rings of the link unit 400 may be coupled to each of a top surface and a bottom surface of the base support plate 430.

In this embodiment, the support rings disposed on the left side with reference to FIG. 9 may support the rotation of the first end link 461 and the eighth end link 468, and the support rings disposed on the right side may support the rotation of the fourth end link 464 and the fifth end link 465.

In this embodiment, when the first extendable housing 323 and the second extendable housing 333 move, the first moving bodies 410, the second moving bodies 420, the base support plate 430, and the support rings may move in the same direction as the movement direction of the first extendable housing 323 and the second extendable housing 333.

As illustrated in FIG. 9, the link part 450 of the link unit 400 includes: a first link body 451 rotatably coupled to the top surface of the base support plate 430 and having one end disposed on the left; a second link body 452 rotatably coupled to the bottom surface of the base support plate 430, having one end disposed on the right and arranged to intersect the first link; a third link body 453 rotatably coupled to the bottom surface of the base support plate 430 and having one end disposed on the left; and a fourth link body 454 rotatably coupled to the top surface of base support plate 430, having one end disposed on the right, and arranged to intersect the third link body 453.

The first link body 451 of the link part 450 includes a first rotational end member 451a that is rotatably coupled to the upper end, as illustrated in FIG. 9. In this embodiment, one end of the first rotational end member 451a may be rotatably coupled to the first link body 451 and the other end may be rotatably coupled to a third end link 463.

In this embodiment, the first rotational end member 451a may be provided with a protrusion that is inserted into a hole provided in the third end link 463, and when an end link 460 is provided in a substantially circular shape, the first rotational end member 451a may be arranged substantially perpendicular to the first link body 451.

The second link body 452 of the link part 450 includes a second rotational end member 452a that is rotatably coupled to the upper end, as illustrated in FIG. 9. In this embodiment, one end of the second rotational end member 452a may be rotatably coupled to the second link body 452, and the other end may be rotatably coupled to the second end link 462.

In this embodiment, the second rotational end member 452a may be provided with a protrusion that is inserted into a hole provided in the second end link 462, and when the end link 460 is provided in a substantially circular shape, the second rotational end member 452a may be arranged substantially perpendicular to the second link body 452.

The third link body 453 of the link part 450 includes a third rotational end member 453a that is rotatably coupled to the lower end, as illustrated in FIG. 9. In this embodiment, one end of the third rotational end member 453a may be rotatably coupled to the third link body 453, and the other end may be rotatably coupled to the sixth end link 466.

In this embodiment, the third rotational end member 453a may be provided with a protrusion that is inserted into a hole provided in the sixth end link 466, and when the end link 460 is provided in a substantially circular shape, the third rotational end member 453a may be arranged substantially perpendicular to the third link body 453.

The fourth link body 454 of the link part 450 includes a fourth rotational end member 454a that is rotatably coupled to the lower end, as illustrated in FIG. 9. In this embodiment, one end of the fourth rotational end member 454a may be rotatably coupled to the fourth link body 454, and the other end may be rotatably coupled to the seventh end link 467.

In this embodiment, the fourth rotational end member 454a may be provided with a protrusion that is inserted into a hole provided in the seventh end link 467, and when the end link 460 is provided in a substantially circular shape, the fourth rotational end member 454a may be arranged substantially perpendicular to the fourth link body 454.

In this embodiment, when the extendable driving unit 300 is operated, the link part 450 may smoothly guide the transformation of the end link 460 by folding or unfolding each link body.

The end link 460 of the link unit 400 provides the outer shape of the wheel part 500. As illustrated in FIG. 9, the end link 460 includes: a first end link 461 rotatably coupled to an upper portion of the base support plate 430 on the left; a second end link 462 rotatably coupled to the first end link 461 and having one side to which a second rotational end member 452a is rotatably coupled; a third end link 463 rotatably coupled to an end of the second end link 462 and having one side to which a first rotational end member 451a is rotatably coupled; a fourth end link 464 having one side to which an end of the third end link 463 is rotatably coupled and the other side which is rotatably coupled to the upper portion of the base support plate 430 disposed on the right; a fifth end link 465 rotatably coupled to the lower portion of the base support plate 430 disposed on the right; a sixth end link 466 rotatably coupled to an end of the fifth end link 465 and having one side to which a third rotational end member 453a is rotatably coupled; a seventh end link 467 rotatably coupled to an end of the sixth end link 466 and having one side to which a fourth rotational end member 454a is rotatably coupled; and an eighth end link 468 having one side rotatably coupled to the seventh end link 467 and the other side rotatably coupled to a lower portion of the base support plate 430 arranged on the left with reference to FIG. 9.

In this embodiment, the first end link 461 may be provided identically or similarly to the fourth end link 464, the fifth end link 465, and the eighth end link 468, the second end link 462 may be provided identically or similarly to the sixth end link 466, and the third end link 463 may be provided identically or similarly to the seventh end link 467. In this embodiment, the lengths of the first end link 461, the fourth end link 464, the fifth end link 465, and the eighth end link 468 may be the longest, followed by the lengths of the third end link 463 and the seventh end link 467, and the lengths of the second end link 462 and the sixth end link 466 may be the shortest. This is to maintain support on various terrains, road conditions, or ground environments, while also allowing for easy shape transformation.

The wheel part 500 is coupled to the end link 460, allowing its shape to be transformed along with the end link 460, and can be rotated by receiving power from the rotational driving part 200.

In this embodiment, the wheel part 500 includes a plurality of chain members 510 continuously coupled to the end link 460 illustrated in FIG. 9, and a plurality of finishing bars 520 respectively coupled to the plurality of chain members 510.

In this embodiment, as illustrated in FIG. 14, the plurality of chain members 510 may be connected to the first gear 228, the first unit gear 229, the second gear 238, and the second unit gear 239, and may rotate by receiving the rotational force of each gear.

As described above, this embodiment is capable of providing a transformable wheel assembly, enabling active driving in increasingly complex and diverse environments.

In addition, this embodiment is capable of simplifying a coupling structure between a mobile vehicle and a driving part by providing a structure in which a single driving body transforms between a wheel and a continuous track.

As described above, it is evident to a person ordinarily skilled in the art that the present disclosure is not limited to the described embodiments, and various modifications and variations can be made without departing from the technical idea and scope of the present disclosure. Therefore, such modifications or variations should be considered as falling within the scope of the claims of the present disclosure.

1. A transformable wheel assembly comprising:
a main frame provided with a main driving shaft that is connected to and rotated by driving means of a driving body comprising a vehicle;
a rotational driving part provided on the main frame and connected to the driving means, the rotational driving part being configured to provide rotational power separately from the main driving shaft;
an extendable driving part provided on the main frame and connected to the driving means; and
a link unit provided on the main frame and forming an outer shape of a wheel part, the link unit being configured to transform a shape of the wheel part into a modified shape comprising a circular or elliptical shape in response to operation of the extendable driving part,
wherein the rotational driving part is connected to the wheel part and provides rotational power separately from the main driving shaft.

2. The wheel assembly of claim 1, wherein the rotational driving part comprises:
a driving power transmission part provided on the main frame and connected to the driving means to receive power;
a first driven power transmission part provided on the main frame and meshed with a driving power transmission gear of the driving power transmission part, the first driven power transmission part being configured to receive and transmit rotational power to the wheel part; and
a second driven power transmission part provided on the main frame opposite to the first driven power transmission part and meshed with the driving power transmission gear, the second driven power transmission part being configured to receive and transmit rotational power to the wheel part.

3. The wheel assembly of claim 2, wherein the extendable driving part comprises:
an extendable power transmission part provided on the main frame and connected to the driving means to receive power;
a first moving part provided on the main frame and comprising a first extendable housing meshed with the extendable power transmission gear of the extendable power transmission part, the first extendable housing being configured to move along a longitudinal direction of the main frame using power received from the extendable power transmission gear; and
a second moving part provided on the main frame opposite to the first moving part and comprising a second extendable housing meshed with the extendable power transmission gear, the second extendable housing being configured to move in an opposite direction to the first moving part using power received from the extendable power transmission part,
wherein, when the first extendable housing moves, a first gear and a first unit gear of the rotational driving part also move along with the first extendable housing, and
wherein, when the second extendable housing moves, a second gear and a second unit gear of the rotational driving part also move along with the second extendable housing.

4. The wheel assembly of claim 2, wherein the link unit comprises:
a plurality of first moving bodies provided to move in a front guide hole of the main frame and coupled to a first extendable guider provided in the extendable driving part to be moved along with the first extendable guider;
a plurality of second moving bodies provided to move in a rear guide hole of the main frame and coupled to a second extendable guider provided in the extendable driving part to be moved along with the second extendable guider;
a pair of base support plates respectively coupled to the plurality of first moving bodies and the plurality of second moving bodies arranged on one side of the main frame and respectively coupled to the plurality of first moving bodies and the plurality of second moving bodies arranged on another side of the main frame to be moved in opposite directions;
a link part comprising a plurality of link bodies respectively provided on the pair of base support plates that are close to each other; and
an end link having one side rotatably coupled to the pair of base support plates and another side coupled to the link part to be transformed into the modified shape.

5. The wheel assembly of claim 4, wherein the link unit further comprises
support rings provided on the pair of base support plates to support the first moving body and the second moving body and to support one side of the end link.

6. The wheel assembly of claim 4, wherein the pair of base support plates are engaged with connecting frame provided on the main frame such that a movement distance on one side is limited.

7. The wheel assembly of claim 2, wherein the main frame comprises:
a front guide configured to guide movement of a first extendable guider and a second extendable guider of the extendable driving part; and
a rear guide configured to guide movement of a first guider and a second guider of the rotational driving part,
wherein the wheel part is provided on the link unit to be transformed into a shape corresponding to the modified shape of the link unit.
